(19) United States
(12) Patent Application Publication
(10) Pub. No.: US 2014/0252156 A1
(43) Pub. Date: Sep. 11, 2014

(54) High Altitude Aircraft, Aircraft Unit and Method for Operating an Aircraft Unit

(71) Applicant: EADS Deutschland GmbH, Ottobrunn (DE)

(72) Inventors: Manfred Hiebl, Neuburg a.d. Donau (DE); Hans Wolfgang Pongratz, Taufkirchen (DE)

(73) Assignee: EADS Deutschland GmbH, Ottobrunn (DE)

(21) Appl. No.: 14/354,030

(22) PCT Filed: Oct. 20, 2012
(86) PCT No.: PCT/DE2012/001021

§ 371 Date: Apr. 24, 2014

(30) Foreign Application Priority Data
Oct. 25, 2011 (DE) 10 2011 116 841.2

(51) Int. Cl. B64C 39/02; B64D 39/00; B64C 27/41; B64C 9/00

(52) U.S. Cl. CPC B64C 39/02; B64C 9/00; B64D 39/00; B64C 27/41
USPC 244/3; 244/201

(57) ABSTRACT

A high-altitude unmanned stratosphere aerial vehicle includes a fuselage, wings, control surfaces, and a propulsion system including an engine and a propeller. Each wing has a plurality of hoses and wing spars extending in a direction perpendicularly to the longitudinal fuselage axis and are surrounded by a skin forming a wing covering that determines the cross-sectional contour of the wing, the cross-sectional contour forming a laminar flow airfoil that generates high lift when there is low flow resistance. At the free end facing away from the fuselage, each wing has a winglet extending transversely to the longitudinal wing axis. The winglet has a movable control surface, which allows an aerodynamic side force to be generated so as to bring the aerial vehicle to a banked position.

### TECHNICAL FIELD

The present invention relates to a high-altitude unmanned aerial vehicle, in particular a stratosphere aerial vehicle, comprising at least one fuselage, wings, control surfaces and at least one propulsion system including at least one engine and at least one propeller. In particular, the invention relates to a high-speed, high-altitude unmanned aerial vehicle having its own solar propulsion system and additional fuel supply by aerial refueling with hydrogen gas from a solar-powered, lower-flying tanker aircraft, which produces hydrogen gas using solar energy by way of electrolysis from water the aircraft carries.

The present invention further relates to an aerial vehicle formation comprising at least one first high-altitude unmanned aerial vehicle and at least one second high-altitude unmanned aerial vehicle, wherein the second high-altitude unmanned aerial vehicle forms a refueling aircraft for the first high-altitude unmanned aerial vehicle.

Finally, the present invention also relates to a method for operating such an aerial vehicle formation.

### BACKGROUND OF THE INVENTION

An essential problem of protecting a territory from hostile attacks today is to discover rockets, such as missiles, approaching this territory early enough so that effective combating of these rockets is possible. Carrying out such air space monitoring by way of satellites is very expensive and complex. An observation platform positioned at high altitude, for example in the stratosphere up to 38 km high, could therefore represent an alternative to satellites.

Stratosphere platforms could also be used for other tasks typically carried out by satellites at altitudes over 20 km, where there are no longer jet streams with speeds over 60 m/sec and no clouds having strong turbulence. Such stratosphere platforms must be operational around the clock, which means that they must have an energy consumption that is as low as possible and be equipped with autonomous energy sources. Nevertheless, complete energy autonomy will not be achievable, so that such a high-altitude aircraft must also be supplied with external energy, which can be carried out by tanker aircraft, for example.

The associated tanker aircraft will normally fly above the clouds, with low energy consumption of their own and with efficient solar energy generation and storage, and will avoid jet stream turbulence areas horizontally or vertically.

For example, the high-altitude aerial vehicles can be used as relay stations for wireless signal transmission so as to replace communication satellites, or to supplement these by additional broadband data links, which are not exposed to high attenuation due to clouds and rain and are thus able to bridge longer distances with less energy. Moreover, radar devices can see further from a high altitude, up to the horizon, and can achieve considerably higher ranges, in particular during poor weather, since the radar beam then has to travel only the smaller portion of the distance through rain or clouds.

Problems of aerial surveillance can thus be solved by permanent aircraft flying at high altitude and can thus be solved by a special, lightweight high-altitude aerial vehicle, which does not have to withstand the high winds, and optionally heavy rains, encountered at lower altitudes.

### STATE OF THE ART

Balloon-based unmanned aircraft are known from the general prior art, which can achieve comparable flying altitudes and have low operating costs. However, these balloon aircraft cannot be maneuvered to the required extent, both in terms of the altitude and in terms of the horizontal, and are thus not able, for example, to maintain a predefined position under the winds prevailing at these high altitudes. In particular the jet stream prevailing at high altitudes, the path of which is not constant, requires appropriate maneuverability of a high-altitude aircraft to allow the same to be positioned outside, or at the edge, of the jet stream, for example in such a way that it is substantially stationary in relation to a location on the earth's surface. Known balloons are able to cover noteworthy distances only if they ride with the jet stream.

Moreover, conventional aircraft are known, which have the required maneuverability, but allow only a very limited flight duration and cause very high operating costs in the process.

During the years between 1995 and 2005, solar-powered high-altitude aerial vehicles were developed on an experimental basis, which featured energy generation by solar cells on all suitable surfaces, and energy storage by a cycle of a water electrolysis device for decomposing water into hydrogen gas and oxygen gas, storage of the hydrogen and oxygen gases in high-pressure storage units (up to 700 bar), and recovery of the electrical energy in hydrogen-oxygen fuel cells.

The implemented aircraft were NASA's Pathfinder and Helios, which were both tested successfully up to flying altitudes of 30 km, and the HeliPlat, a project and prototype of the European Space Agency, ESA, which is to reach a flying altitude of 21 km.

These aircraft reached an energy density of 400 Watt hours per kilogram. The wings of the aircraft had an extreme span of up to 30, and a very soft wing with large deflection, which made the aircraft very susceptible to gusts. The Helios aircraft was lost as a result of a gust following extreme wing deflection due to structural failure. The energy density achieved in these aircraft is considerably higher than the value of 200 Wh per kg that is achievable with lithium-ion batteries. These are used in the manned solar-powered plane “Solar Impulse”; however this aircraft only reaches altitudes of 10 km.

### SUMMARY OF THE INVENTION

Thus, exemplary embodiments of the present invention provide a high-altitude unmanned aerial vehicle that is able to fly in the upper stratosphere up to an altitude of approximately 38 km with substantially unlimited flying time, and which can either be positioned in a stationary manner above ground, against the presently prevailing winds at high altitude or, if needed, can cover large distances, such as 3000 km, at sufficient speed, such as 250 km/h. Such a high-altitude aerial vehicle is also supposed to be able to carry, and operate, appropriate payload gear as well as propulsion, flight control and communication gear and the energy supply required for this purpose. Further exemplary embodiments of the invention provide an aerial vehicle formation composed of high-altitude aerial vehicles according to the invention, of which at least one is a refueling aircraft. Finally, another object is to provide a method for operating such an aerial vehicle formation.

### Advantages

The high-altitude unmanned aerial vehicle, which comprises at least one fuselage, wings, control surfaces and at least one propulsion system including at least one engine and one propeller, is characterized in that each wing has a plurality of hoses and wing spars that extend in a direction transversely, preferably perpendicularly, to the longitudinal fuselage axis and are surrounded by a skin forming a wing covering. This wing covering determines the cross-sectional contour of the wing, which forms a laminar flow airfoil that generates high lift when there is low flow resistance. At the free end facing away from the fuselage, each wing is provided with a winglet extending transversely to the longitudinal wing axis. The winglet is provided with a movable control surface, which allows an aerodynamic side force to be generated so as to be able to bring the aerial vehicle to a banked position. The fuselage preferably has a tubular design and is formed of a carbon fiber composite material tube, for example.

Such a high-altitude unmanned aerial vehicle according to the invention, which due to a particularly lightweight design is suited in particular as a stratosphere aerial vehicle, is advantageously designed as an aircraft having a thick (18% airfoil thickness, for example) curved (4.2% curvature, for example) laminar flow airfoil wing, which generates high lift with low drag at high coefficients of lift and has a large volume. The high-altitude aerial vehicle only has to withstand the turbulences at high altitudes, does not have to endure rain, and must be able to withstand the dynamic pressures at approximately 30 m/sec at an altitude of 15 km. The aerial vehicle is therefore designed for loads of plus 2.5 g and minus 2 g. Moreover, the aerial vehicle must withstand the stress during rolling on the ground and during take-off and landing in calm air.

Since the high-altitude aerial vehicle is provided with at least one propulsion system comprising a propeller, the aerial vehicle is additionally enabled to independently carry out a horizontal position change, regardless of any wind that may be present. Such a high-altitude aerial vehicle that is provided with a propulsion system is thus maneuverable both horizontally and vertically.

On the inside in the wing span direction, the wing comprises multiple pressure-resistant (preferably resistant up to 1.5 bar of overpressure) hoses made of aluminized aramid film (such as KEVLAR® film) for UV protection and for gas sealing purposes, which substantially take up the wing profile.

These hoses, which form chambers for gas storage, can each be filled, preferably separately, with pure hydrogen gas and pure oxygen gas to ⅔ and ⅓, respectively, of the available volume, at a pressure of 0.2 up to 1.2 bar. This low working pressure of the wing storage units of maximally 1.2 bar overpressure allows very energy-efficient operation compared to a high-pressure storage unit having 700 bar of operating pressure, in which a considerable percentage of the generated energy is used to compress the hydrogen gas, this energy then being lost. The storage energy density of the high-altitude aerial vehicle according to the invention reaches 1300 Wh per kg.

For high-altitude flying, the wing must have an extremely lightweight design. It is particularly advantageous for this purpose if the wing comprises a shell with an aerodynamic shape in the longitudinal section and is made of a thin film, preferably a transparent polyester film, on the top side and a high-strength aluminized aramid film on the wing bottom side to protect against UV radiation.

A transparent polyester film that is particularly suited due to its strength is a biaxially oriented polyester film, as it is available on the market under the trade name “MYLAR®”, for example.

Thin-film solar cells of the CIGS (copper indium gallium selenide) type are advantageously applied beneath the transparent polyester film across the entire top side of the wing and the top side of the horizontal stabilizer, the cells being advantageously applied to a thin polyimide film (such as KAPTON® film) and covered by another film, wherein the entire composition advantageously is only approximately 50 μm thick and thus very light in weight and achieves efficiency of up to 16%. Such CIGS thin-film solar cells have a very low weight and operate well without separate cooling devices even at elevated temperatures, as they may occur in high altitudes, so that a very lightweight solar generator is formed in conjunction with the carrier element formed of a thin film.

It is further advantageous if the wing, in the wing span direction, comprises at least two hoses that can be filled with hydrogen gas and one hose that can be filled with oxygen gas, or at least one corresponding tubular gas-tight spar, which additionally reinforces or reinforce the wing in the wing span direction when it is or when they are filled. It is further advantageous to dispose an overpressure hose or tubular spar in the nose of the wing profile, the hose or spar having the same radius as the wing profile and thus forming a dimensionally stable lightweight leading edge of the wing, which is able to be supported on the hoses located behind the same. Additionally, the hoses or tubular spars are disposed on the inside of the profile in such a way that the outer skin is stretched in the desired profile shape over the hoses or tubular spars and thus a very smooth wing having no creases is created, which is suitable as a laminar flow airfoil. In addition to the wing spar or spars and the pressure hoses, this design requires only few very lightweight ribs, so that a very lightweight wing of high aerodynamic quality is created with the stretched skin.

The respective tubular and gas-tight wing spar is advantageously designed so that an inner tube (inside tube) absorbs the internal pressure and the tensile and pressure forces from the wing bending moment and the wing pressure forces acting on the surface component at the spar. A longitudinally undulated outside tube is placed around this inside tube and is glued continuously along the contact surfaces over the entire surface, whereby a uniform tubular supporting member is created.

Each wing is preferably provided with at least one propulsion nacelle for accommodating a propulsion system.

It is particularly advantageous if the fuselage is provided with a guyed mast extending upward and downward away from the fuselage and if tensioning devices are provided, which brace the wings, preferably the free ends thereof, and/or the propulsion nacelles with respect to the fuselage and/or the guyed mast.

So as to obtain a wing that is as rigid and as lightweight as possible, the bending moment in the wing root is reduced to as great an extent as possible as a result of the bracing via the guyed mast in the center of the wing, for example to the propulsion nacelles, over two thirds of the wing span. Together with the thick (18% airfoil thickness) wing profile, which allows a favorable tall construction of the wing spar, in this way also a wing is created that has very low weight and is much more rigid than a non-guyed wing.

By reinforcing the wings and selecting an aspect ratio of 16, for example, with the winglets measuring 7.5 m in height, for example, at a wing span of 50 m and 250 m² wing area, problems with the wing's aeroelasticity in gusty air are avoided, which resulted in the in-flight destruction of the Helios aircraft prototype, for example.

The wing is preferably distinguished by being extremely low weight by receiving its rigidity in the wing span direction preferably from two tubular wing spars made of Kevlar film or woven high-strength CFRP fabric. The wing is additionally braced at the center by the guyed mast. This minimizes the bending moments in the wing spars and achieves the most lightweight design possible. Due to the hydrogen chambers, the wing has both an aerostatic lift component and, with appropriate incident flow, an aerodynamic lift component.

The at least one propeller is preferably provided with flapping hinges in the manner of a helicopter rotor.

It is particularly advantageous if the at least one propeller has as large a diameter as possible, which results in low propulsion energy consumption. With large propeller diameters, considerable disturbance torques can be transmitted to the propeller shaft in the case of unsymmetrical incident flow, which significantly impair the use of optical sensors (such as for reconnaissance purposes) due to the generation of vibrations. The propeller blade is thus advantageously designed to be continuous in the manner of a helicopter rotor, having a flapping hinge on the shaft that allows flapping in the direction of flight. As a result of the flapping, the disturbance forces are advantageously aerodynamically compensated for, and no additional disturbance torques can be transmitted any longer to the propeller shaft.

A high-altitude aerial vehicle according to the invention having at least one electric motor is particularly preferred. A photovoltaic energy supply system is provided in this high-altitude aerial vehicle for generation of the propulsion energy. This energy supply system comprises at least one photovoltaic solar generator, which converts impinging radiant solar energy into electrical energy. This system additionally has at least one water electrolysis device for generating hydrogen and oxygen from water, which operates at ground pressure that is kept constant so as to avoid contamination of the gases by hydrogen diffusion. The energy supply system further comprises the following: at least one hydrogen reservoir, which is connected to the water electrolysis device via a first water line; at least one hydrogen reservoir, which is preferably formed by a first hose and which is connected to the water electrolysis device via a first hydrogen line; at least one oxygen reservoir, which is preferably formed by a second hose and which is connected to the water electrolysis device via a first oxygen line; at least one fuel cell, which operates in a closed loop at a ground pressure that is kept constant, so that contaminations of the fuel gases by carbon dioxide can be prevented, wherein the fuel cell is connected to the hydrogen reservoir via a second hydrogen line and is connected to the oxygen reservoir via a second oxygen line and is further connected to the water reservoir via a second water line. Finally, this high-altitude aerial vehicle is also provided with a control unit, which is electrically connected to the solar generator, the water electrolysis device and the fuel cell.

This energy supply system enables the high-altitude aerial vehicle to automatically generate hydrogen and oxygen from water by way of the solar generator and the water electrolysis device so as to operate a fuel cell, which supplies the electrical energy required for propulsion of the aerial vehicle, among other things.

However, the at least one engine can also comprise a hydrogen oxygen internal combustion engine.

The solar generator preferably comprises at least one carrier element provided with CIGS thin-film solar cells and formed by a thin film, preferably a polyimide film. The CIGS solar generator achieves high efficiency of 16% at a basis weight of less than 100 g/m².

It is particularly preferred if the solar cells are thin-film solar cells, wherein these are preferably cadmium telluride cells. Such thin-film solar cells likewise have a very low weight, so that a very lightweight solar generator is formed in conjunction with the carrier element formed of a thin film. The cadmium telluride thin-film cells have a lower efficiency of 9%, but are considerably lighter than the CIGS thin-film solar cells.

The energy supply system is preferably additionally provided with an electrical energy storage unit, which is designed as a rechargeable battery, for example. This electrical energy storage unit forms an intermediate storage unit that is able to give off electrical energy quickly if the power generator is not supplied with sufficient radiant energy over a short period. This electrical energy storage unit thus bridges the time required to activate the fuel cell or, if the fuel cell is not activated, to bridge the time that must be bridged, for example, when the sunlight is briefly blocked until the sunlight impinges on the power generator again.

The photovoltaic energy supply system according to the invention is preferably provided with a control unit, which is designed, when radiant energy is present, to supply the electrical energy generated by the power generator to an electrical consumer connection of the energy supply system and, when radiant energy is not present or when the electrical energy generated by the power generator is not sufficient for a predetermined energy requirement, the fuel cell is activated so as to supply electrical energy to the consumer connection. This control unit can thus ensure that the fuel cell is automatically activated if insufficient or no radiant energy is available.

Preferably the control unit is designed such that it supplies a portion of the electrical energy generated by the power generator to the hydrogen generator, in particular when radiant solar energy is present, and that it supplies water from the water reservoir to the hydrogen generator, so that the hydrogen generator is activated in order to generate hydrogen from the water that is supplied thereto, the hydrogen being stored in the hydrogen reservoir. In this embodiment, a portion of the electrical energy generated by the power generator is used to operate the hydrogen generator, so as to generate the hydrogen that the fuel cell requires to generate electrical energy if the power generator does not supply any, or not sufficient, electrical energy. The control unit can thus control the amount of electrical energy supplied to the hydrogen generator, or also the activation times of the hydrogen generator, as a function of the available hydrogen supply.

It is also advantageous if a portion of the electrical energy generated by the power generator and/or by the fuel cell is supplied to the energy storage unit so as to charge the same. This ensures that electrical energy is always temporarily stored in the energy storage unit so as to be able to be retrieved directly therefrom if needed.

In one special embodiment of the high-altitude aerial vehicle, the skin of the wing covering is weatherproof, in particular rainproof, so that the aerial vehicle is also suitable for flying in the tropopause and the troposphere. This variant of the high-altitude unmanned aerial vehicle is particularly suitable for being used as a refueling aircraft, which can fly as a stratosphere aircraft at lower altitudes and is traveling there at a higher air density with lower energy expenditure for the time period where hydrogen and oxygen are generated from water by way of radiant solar energy.

This aerial refueling-capable, specialized solar energy collection and in-flight refueling aircraft is particularly suited as an aircraft for altitudes of 3 km to 21 km due to a strong, yet lightweight design. As an aircraft, it is advantageously designed with a thick (18% airfoil thickness, for example) curved (2.1% curvature, for example) laminar flow airfoil wing, which generates high lift with low drag and small coefficients of lift and has a large volume. This refueling aircraft (tanker) must be able to withstand the turbulences that occur at higher altitudes and must endure some rain and be able to withstand the dynamic pressures at 30 m/sec at an altitude of 15 km. The aircraft is therefore designed for loads of plus 6 g and minus 3 g. Moreover, the aircraft must withstand the stress during rolling on the ground and during take-off and landing in calm air.

On the inside in the wing span direction, the wing of this refueling aircraft comprises multiple pressure-resistant (preferably resistant up to 2.5 bar of overpressure) hoses made of aluminized aramid film (such as KEVLAR® film) for UV protection and for gas sealing purposes, which largely take up the profile. These hoses can each be filled separately with pure hydrogen gas and pure oxygen gas to ⅔ and ⅓, respectively, of the available volume, at a pressure of 1.2 bar up to 2.2 bar. This low working pressure of the wing storage units of maximally 2.2 bar allows a very energy-efficient storage operation compared to a high-pressure storage unit having 700 bar of operating pressure, in which a considerable percentage of the generated energy is used to compress the hydrogen gas, this energy then being lost.

The storage energy density of the tanker aircraft reaches 2600 Wh per kg because the static lift of the stored hydrogen gas has a greater effect at lower altitudes below 10 km, and very efficient energy collection is thus possible.

The aerial vehicle formation is achieved by an aerial vehicle formation comprising at least one first high-altitude unmanned aerial vehicle, which forms a stratosphere aerial vehicle, and at least one second high-altitude unmanned aerial vehicle, in which the skin of the wing covering is designed to be weatherproof, in particular rainproof, so that this second aerial vehicle is also suitable for flying in the tropopause and the troposphere, wherein this second high-altitude aerial vehicle forms a refueling aircraft for the first high-altitude aerial vehicle. Using such an aerial vehicle formation, it is possible to leave the first high-altitude aerial vehicle positioned virtually permanently in the stratosphere, for example as a reconnaissance platform, and to refuel this first aerial vehicle as needed by way of the refueling aircraft. The aerial vehicle formation according to the invention thus is a cooperating group of at least two specialized aerial vehicles, which is to say at least one solar energy collection and tanker aircraft and at least one high-altitude aerial vehicle for altitudes up to 38 km, which can be refueled in-flight.

In the method according to the invention, the refueling aircraft establishes a refueling connection with the first aerial vehicle while the two aerial vehicles are flying, hydrogen gas being delivered to a hydrogen storage unit (hose storage unit) of the first aerial vehicle and oxygen gas being delivered to an oxygen storage unit (hose storage unit) of the first aerial vehicle by the refueling aircraft via this refueling connection. Meanwhile, water, which was created in the fuel cell of the first aerial vehicle, is supplied by the first aerial vehicle back to the refueling aircraft. At the end of the refueling process, the refueling aircraft descends to a lower altitude, where it generates hydrogen gas and oxygen gas again by way of the on-board water electrolysis device and collected solar energy, using the water taken up during refueling, and optionally water taken up from the surroundings. These two newly generated gases are stored in the corresponding on-board hydrogen storage units and oxygen storage units. After conclusion of the gas generation process, the refueling aircraft ascends again to a higher flight altitude so as to be able to carry out another refueling process on a first aerial vehicle (stratosphere aerial vehicle).

Aerial refueling preferably takes place at altitudes of 15 to 20 km. The tanker has a starting storage pressure of no more than 2.2 bar, which decreases to 1.2 bar over the course of the refueling process. The high-altitude aerial vehicle to be refueled has a starting storage pressure of 0.2 to 0.3 bar and over the course of the refueling process attains a final pressure of no more than 1.2 bar when it is completely refueled. The transfer of the gas takes place as a result of the pressure differential, without pumps. The transferred amount of fuel is preferably 80 standard cubic meters hydrogen gas and 40 standard cubic meters oxygen gas. A high storage capacity is achieved with a low storage weight at the pressures that are selected according to the invention.

The hydrogen containers advantageously also serve as lifting bodies at lower flight altitudes and thus reduce the propulsion power required. By disposing the fuel gas storage units in the thick laminar wing advantageously no additional air drag is created by the fuel storage units, and the lift effect of the hydrogen gas advantageously creates lift and no additional weight, as would be the case with batteries for energy storage, for example.

The energy storage takes place by decomposing water into hydrogen gas and oxygen gas by way of PEM water electrolysis using solar energy. The electrolysis is advantageously carried out at an operating pressure that is kept constant at ground pressure. In this way, diffusion of the produced hydrogen into the oxygen outlet of the electrolysis device can be kept to very small amounts, and thus pure gas can be generated, so that no purification of the high weight gas must be carried out, even during long-term operation, and high efficiency of more than 70% can be achieved.

The pure hydrogen and oxygen gases can either be converted in a PEM fuel cell (polymer electrolyte membrane fuel cell) so as to generate electrical current, or they can be used directly in a hydrogen oxygen internal combustion engine according to the diesel principle as mechanical energy for driving the propellers.

Driving of the fuel cells is advantageously carried out by way of the pure gases that are carried on-board and contain no carbon dioxide gas contamination, which otherwise would have to be removed, involving high complexity, in order to avoid damage to the fuel cells. The fuel cells are advantageously operated at a constant ground pressure, whereby high efficiency of more than 60% can be achieved.

At high altitudes, neither the fuel cells nor the hydrogen combustion engine operate well at the low ambient pressure of 1/100 bar. As a result, both are advantageously operated at the constant pressure of 1.2 bar that prevails in the hydrogen supply tank. At this pressure, it is advantageously possible to cool the components and operate the devices.

Preferred exemplary embodiments of the invention, including additional design details and further advantages, are described and explained in more detail hereafter with reference to the accompanying drawings.

### BRIEF DESCRIPTION OF THE DRAWINGS

In the drawings:

FIG. 1 shows a rear view of a high-altitude aerial vehicle according to the invention in the direction of flight;

FIG. 2 shows a perspective view of the high-altitude aerial vehicle according to the invention of FIG. 1;

FIG. 3 shows a cross-sectional view through a wing along line of FIG. 1;

FIG. 4 shows a cross-sectional view through a reinforced tubular spar;

FIG. 5 shows a formation comprising a refueling aircraft and a high-altitude aerial vehicle to be refueled;

FIG. 6 shows a schematic illustration of the energy supply system of the high-altitude aerial vehicle according to the invention;

FIG. 7 shows a schematic flow chart of a refueling cycle in a formation according to FIG. 4; and

FIG. 8 shows a schematic sectional illustration along line XIII-XIII of FIG. 3 of the integration of work machines into a hydrogen tank.

### DETAILED DESCRIPTION OF PREFERRED EXEMPLARY EMBODIMENTS

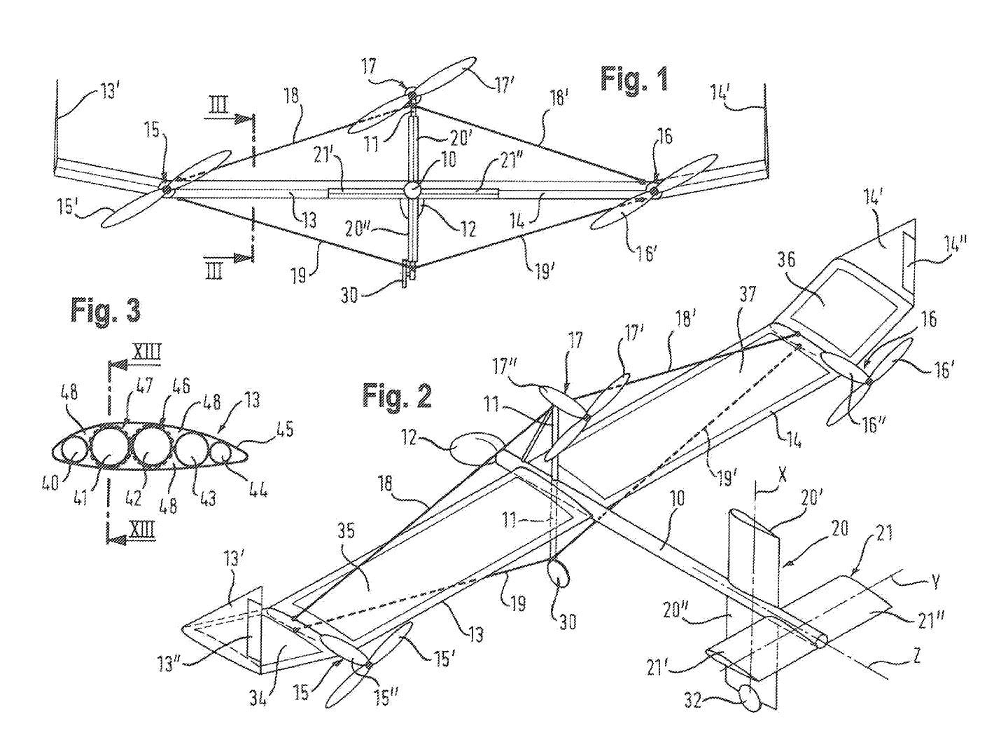

FIG. 1 shows a rear view of a high-altitude aerial vehicle according to the invention in the direction of flight. Two wings 13, 14 are provided on the side of a tubular fuselage 10 (FIG. 2), which has a balloon-like tip 12 at the fuselage nose. A substantially vertically extending winglet 13′, 14′ is provided at the free ends of each wing 13, 14. A propulsion nacelle 15, 16 is attached to each wing 13, 14 at approximately ⅔ the distance from the fuselage, each propulsion nacelle accommodating a motor 15″, 16″, which drives an associated propeller 15′, 16′ in each case. For example, a radar device can be provided in the balloon-like fuselage nose 12, which is designed as a radome.

A third propulsion nacelle 17 is attached to the top of a guyed pole 11 protruding upward from the wing. The third propulsion nacelle 17 also comprises a motor 17″, which drives an associated propeller 17′. While FIGS. 1 and 2 show the propellers 15′, 16′, 17′ as pusher propellers, the propulsion systems can, of course, also be configured with tractor propellers.

The guyed pole 11 extends not only upward from the fuselage 10, but also extends downward beyond the fuselage. An upper left guy wire 18 extends from the upper tip of the guyed pole 11 to the area of the left wing 13 to which the propulsion nacelle 15 is attached. Similarly, an upper right tensioning cable 18′ extends from the upper tip of the guyed pole 11 to the area of the right wing 14 to which the right propulsion nacelle 16 is attached. A lower left tensioning cable 19 extends from the lower end of the guyed pole 11 to the area of the left wing 13 to which the left propulsion nacelle 15 is attached, and a lower right tensioning cable 19′ extends from the lower tip of the guyed pole 11 to the area of the right wing 14 to which the right propulsion nacelle 16 is attached.

The bracing of the free ends of the wing with respect to the fuselage and/or with respect to the guyed pole ensures that the wing does not buckle upward under the load of the lift forces engaging thereon. In addition to the tensioning cables that are provided at the free ends of the wing and those provided at the propulsion nacelles, further tensioning cables may be attached to the wing between the wing and the guyed pole.

At the aft tubular fuselage 10, initially a vertically extending stabilizer 20 and a horizontally extending stabilizer 21 are provided behind one another. The vertical stabilizer 20 is composed of a vertical stabilizer section 20′ provided above the fuselage and a lower vertical stabilizer section 20″ provided below the fuselage 10. Both the upper vertical stabilizer section 20′ and the lower vertical stabilizer section 20″ are mounted on the fuselage 10 so as to pivotable synchronously about a shared vertical stabilizer pivot axis X, which extends perpendicularly to the fuselage axis Z and vertically during horizontal flying, and thus form rudders.

The horizontal stabilizer 21 is also divided into two parts and is composed of a left horizontal stabilizer section 21′ located to the left of the fuselage 10 and a right horizontal stabilizer section 21″ located to the right of the fuselage. The two horizontal stabilizer sections 21′, 21″ are mounted on the fuselage 10 so as to pivot together synchronously about a pivot axis Y, which extends perpendicularly to the longitudinal fuselage axis Z and horizontally during horizontal flying, and thus form elevators.

A landing gear 30, 32, which is shown only symbolically in FIGS. 1 and 2, is provided in each case at the lower end of the guyed pole 11 and at the lower end of the vertical stabilizer 20. The landing gear 30, 32 is installed with low drag in the lower part of the guyed mast 11 and in the lower rudder 20″ so as to be extendible. Payload nacelles (not shown) may also be provided beneath the fuselage or beneath the wings.

It is also apparent from FIG. 2 that the top sides of the wings 13, 14 comprise solar cell panels 34, 35, 36, 37 beneath the skin 45, which is designed to be transparent in the upper region of the wing, the panels being divided into small areas. The horizontal stabilizer 21 can be provided similarly with solar cells. The solar cell panels are joined elastically to the outer skin by way of an adhesive having good thermal conduction properties, so that no loads are transferred to the solar cells.

It is apparent from the cross-sectional view of a wing shown in FIG. 3 that hoses 40, 41, 42, 43 and 44 are provided in the interior of each wing 13, 14, which extend in the longitudinal direction of the respective wing 13, 14, which is to say perpendicularly to the longitudinal fuselage axis Z, and are disposed next to each other so that they support the shell 45 forming the wing covering. The spaces between the hoses 40, 41, 42, 43 and 44 and the shell 45 are cooled by way of a fan (not shown) using ambient air, so that any heat that may develop in the hoses 40, 41, 42, 43, 44 designed as tanks can be dissipated to the surrounding area.

It is also apparent from FIG. 3 that two of the hoses 41, 42 are designed as tubular gas-tight wing spars 46 and 47, which are reinforced to prevent buckling and collapsing. The profiles for reinforcement of the respective wing that are formed of the two wing spars are connected to each other and to the fuselage 10 and support the guyed pole 11.

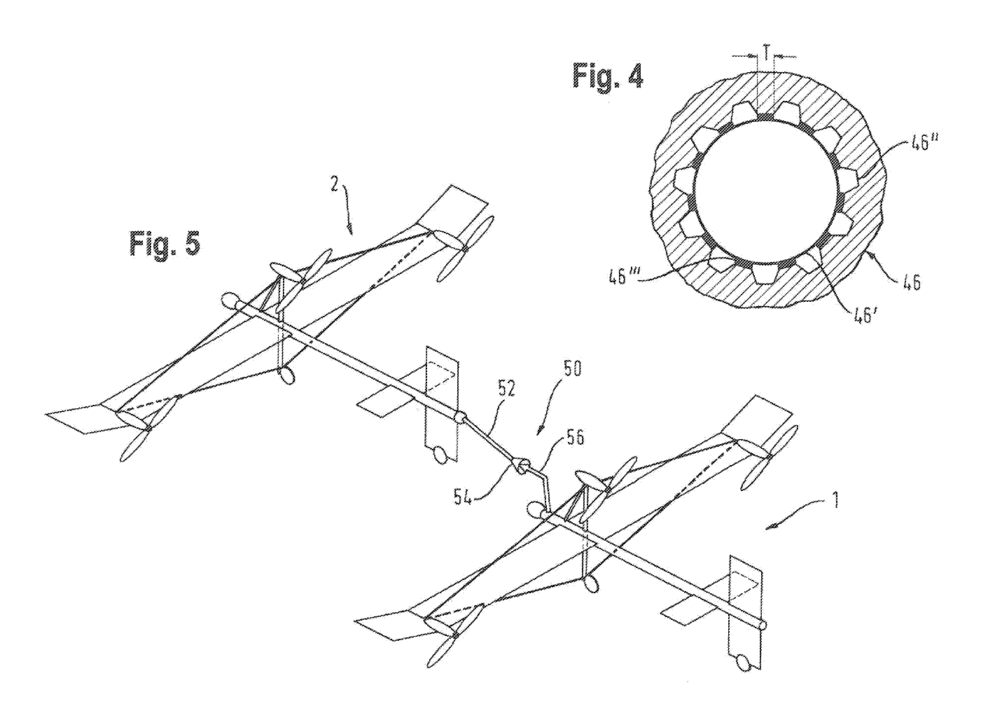

FIG. 4 shows a cross-section through a reinforced tubular wing spar 46, which—like the wing spar 47—is composed of an inside tube 46′ and an outside tube 46″, which is undulated in the longitudinal direction. The inside tube 46′ and the longitudinally undulated outside tube 46″ are continuously glued together at the contact surfaces thereof forming glued points 46″′, so that a uniform supporting member is formed. The gas-tight inside tube 46′ here assumes the task of the hose 41 and thus serves as a receiving chamber for hydrogen gas or oxygen gas.

For example, the inside tube 46′ is a tube made of Kevlar® film or woven fabric made of carbon fiber reinforced plastic and has a diameter of 0.9 m, for example, at a wing span of the aircraft of 50 m. The wall thickness of both the inside tube and of the outside tube is 0.1 mm, for example. The pitch T of the outside tube 46″ is, for example, 5 mm measured in the circumferential direction.

Due to the closed profile, which is composed of the outside and inside tubes, the tubular spar thus formed is reinforced to prevent buckling, so that it can take advantage of the entire design bending moment strength and buckling strength of the overall profile. In addition, the tubular spar is reinforced on the inside at regular intervals by rings having a closed profile, which preserve the spar cross-sections in a smooth and round manner up to the full bending and buckling strength.

The tubular wing spar thus assumes two functions, as a load-bearing element and as a pressure accumulator for hydrogen or oxygen gas. It is particularly advantageous that, for the selected loads and operating pressures, the material thicknesses for the pressure tank are approximately the same as for the supporting spar, however the loads occur in different directions, so that the entire weight of a component that would otherwise have to be additionally provided is thus virtually dispensed with.

The individual hoses 40, 41, 42, 43 and 44 and the tubular wing spars 46 and 47 form chambers for storing hydrogen gas or oxygen gas. At least one of the hoses can also be designed as a chamber for storing water that develops during the energy generation of a fuel cell. The high-altitude aerial vehicle according to the invention, which has very large wings and can reach high speeds, thus allows the hydrogen gas and the oxygen gas to be accommodated in a space-saving manner in the wings having a thick airfoil in pressure-resistant hoses, so that no additional drag is created.

The wing area composed of the two wings 13, 14 is provided with winglets 13′, 14′ at the two ends, which are dimensioned so that they increase the effective aspect ratio by 60% from 10 to 16, without significantly increasing the flight weight. The winglets 13′, 14′ are preferably configured with control surfaces 13″, 14″, so that the high-altitude aerial vehicle can generate a direct side force with appropriate control surface actuation, which allows sideslip-free inclined flying with low drag, at 40° bank angle, for example. If the direction of flight is selected transversely to the incident solar radiation, the impingement angle of the solar rays on the solar cells 34, 35, 36, 37 can thus be made steeper by 40°. At a solar zenith angle of 15° above the horizon, the impingement angle can thus be increased to 55°. As a result, the solar cells are able to use 80% of the solar energy with this maneuver, instead of 25% of the incident solar energy, which is 3.2 times the amount. The energy yield during a day can thus be almost doubled for 6 hours during the morning and evening hours in the tropics, and during the entire day in the mid-latitudes, and can be raised to over 85% of the maximum possible value on a daily average.

FIG. 5 shows an aerial vehicle formation comprising two high-altitude aerial vehicles according to the invention, which is to say a first aerial vehicle 1, which is designed as a stratosphere aerial vehicle and intended for permanent use at extreme altitudes, and a refueling aircraft 2, which has a more robust design and is suitable for use also in the troposphere and tropopause. The refueling aircraft 2 is provided with an extendible refueling tube 52 at the aft fuselage end, which at the free end is configured with a funnel-shaped receiving element 54 for a fold-out forward refueling tube 56 of the first high-altitude aerial vehicle. Such refueling devices are sufficiently known in aeronautical engineering. The first high-altitude aerial vehicle 1 can take up hydrogen and oxygen from the second high-altitude aerial vehicle 2 while in-flight by way of this refueling device 50. The first high-altitude aerial vehicle 1 can give off the water that developed during the combustion process in the fuel cell to the refueling aircraft 2 via the refueling device.

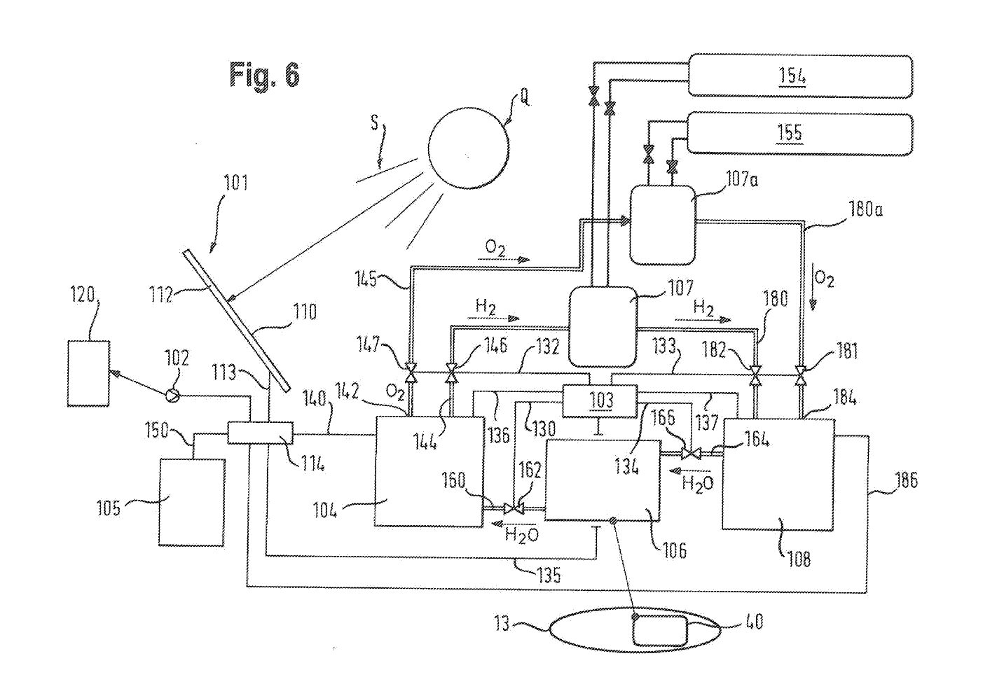

An electric motor has been found to be particularly suitable for the respective propeller propulsion. The propulsion energy for the electric motor, and also for other electrical consumers of the high-altitude aerial vehicle and its payload, is preferably achieved by way of a photovoltaic energy supply system shown in FIG. 6, which is provided with at least one photovoltaic solar generator 101 converting impinging incident solar energy S into electrical energy, a control unit for the solar generator 101, and at least one water electrolysis device for generating hydrogen and oxygen from water.

The energy supply system further comprises at least one water reservoir 106, which is connected via a first water line to the water electrolysis device (hydrogen generator 104), which operates at constant ground pressure. From the water electrolysis device, the generated gases are brought from ground pressure to the storage pressure of the wing tanks of 1.2 bar to 2.2 bar by pumps in the refueling aircraft. The wing tanks comprise at least one hydrogen reservoir 107, which is preferably formed by the first chamber, and an oxygen reservoir 108, which is formed by the second chamber and which is connected to the water electrolysis device via a first hydrogen line and a first oxygen line.

The energy supply system further comprises at least one hydrogen supply container and an oxygen supply container, which are supplied from the wing tanks, and which are kept at a constant ground pressure, and at least one fuel cell, which is connected to the hydrogen reservoir via a second hydrogen line and to the oxygen reservoir via a second oxygen line.

The fuel cell generates water and electrical energy from the gases and is connected via a second water line to the water reservoir, which likewise operates at ground pressure. The energy supply system comprises a control unit 103, which is electrically connected to the solar generator, the water electrolysis device and the fuel cell and which controls the energy supply system so that the payload, the electrolysis device, the motors and the device control unit are supplied with sufficient energy.

FIG. 6 shows the entire solar operation, including the energy storage in the form of hydrogen gas and the closed water and hydrogen gas/oxygen gas cycle. All the devices and motors operate at a constant pressure level of 1.2 bar in a hydrogen atmosphere. This pressure level is also maintained in the hydrogen and oxygen supply tanks.

FIG. 6 shows a power generator, which forms the solar generator 101 and is acted upon by radiant solar energy S. On the surface directed to the sun Q, the solar generator 101 is provided with solar cells, which are applied to a carrier element 112. Even though the figure shows, by way of example, only one carrier element 112 that is provided with solar cells 110, the solar generator 101 can, of course, comprise a plurality of carrier elements 112, which are provided with solar cells 101 over a large area. The solar generator can also comprise other technologies than solar cells, which allow radiant solar energy to be used to generate electrical energy.

The electrical energy generated in the solar generator 101 is supplied to a power distribution device 114 via a first power line 113. The power distribution device 114 is controlled by a central control unit 103 in such a way that a portion of the electrical energy that is supplied via the first power line 113 is forwarded to the hydrogen generator 104, which is designed as a hydrogen electrolysis device.

A portion of the electrical energy that is fed into the power distribution device 114 is conducted to an energy storage unit 105, such as a rechargeable battery, so as to charge the same, if the electrical energy storage unit 105 should not be sufficiently charged. The remainder of the electrical energy that is supplied to the power distribution device 114 is conducted to a consumer connection 102, from where the electrical useful energy made available by the photovoltaic energy supply system can be delivered to electric consumers 120.

The electrical energy storage unit forms an intermediate storage unit that is able to give off electrical energy quickly if the solar generator is not supplied with sufficient radiant energy over a short period. This electrical energy storage unit thus bridges the time that is required to activate the fuel cell or, if the fuel cell is not activated, to bridge the time which must be bridged, for example, when the sunlight is briefly blocked, as it may occur during flight maneuvers, until the sunlight fully impinges on the solar generator again.

The hydrogen generator 104, designed as a hydrogen electrolysis device, is fed with water via a first water line 160 from a water reservoir 106, which is formed by a first chamber of the high-altitude aerial vehicle (such as the hose 40 in the wing 13). An electrically actuatable valve 162 is provided in the first water line 160, the valve being controllable by the control unit 103 via a first control line 130 so as to control the water inflow from the water reservoir 106 to the water electrolysis device 104.

The water that is conducted into the water electrolysis device 104 is decomposed into oxygen and hydrogen by way of electrical energy supplied from the power distribution device 114 via a second electrical line 140. The hydrogen is conducted into a hydrogen supply container 107 via a first hydrogen line 144, the container being maintained at a constant pressure of 1.2 bar by draining hydrogen into the hydrogen wing tanks 154 formed by a first portion of the remaining hoses 41, 42, 43, 44. The oxygen is conducted into an oxygen supply container 107a via a first oxygen line 145, the container being maintained at a constant pressure of 1.2 bar by draining oxygen into the oxygen wing tanks 155 formed by a second portion of the remaining hoses 41, 42, 43, 44. If the pressure in the supply tanks drops below 1.2 bar, the pressure is maintained by replenishing gas from the wing tanks by way of a gas pump.

An electrically actuatable valve 146 is provided in the first hydrogen line 144, the valve being controllable by the control unit 103 via a second control line 132 so as to regulate the volume flow of hydrogen conducted through the first hydrogen line 144 and prevent hydrogen from flowing back out of the hydrogen supply container 107 into the hydrogen generator 104.

The procedure for the oxygen line 145 is analogous, which for this purpose likewise comprises an electrically actuatable valve 147 that is controlled by the control unit 103.

Moreover, FIG. 6 shows a schematic illustration of a fuel cell 108, which is supplied with hydrogen from the hydrogen supply container 107 via a second hydrogen line 180 and with oxygen from the oxygen supply container 107a via a second oxygen line 180a.

If a high power to weight ratio is required, instead of the fuel cell it is possible to provide a hydrogen oxygen internal combustion engine, which is preferably configured with an exhaust gas turbocharger and a high-pressure hydrogen injection unit and which has a downstream second power generator.

An electrically actuatable valve 182 is also provided in the second hydrogen line 180, the valve being controlled by the control unit 103 via a third control line 133 in order to regulate the volume flow of hydrogen through the second hydrogen line 180. The procedure for the second oxygen line 180a is analogous, which for this purpose likewise comprises an electrically actuatable valve 181 that is controlled by the control unit 103.

The fuel cell 108 (or the hydrogen oxygen internal combustion engine) comprises an intake opening 184, through which oxygen from the oxygen supply container 107a can enter. Electrical energy, which is conducted via a fourth power line 186 to the power distribution device 114, is generated in the hydrogen oxygen fuel cell 108 (or in the hydrogen oxygen internal combustion engine having a power generator) from the supplied hydrogen and oxygen in the manner that is known per se.

The water developing in the fuel cell 108 (or in the hydrogen oxygen internal combustion engine) during the recombination of hydrogen and oxygen is conducted into the water reservoir 106 via a second water line 164. An electrically actuatable valve 166 is also provided in the second water line 164, the valve being controllable by the control unit 103 via a fourth control line 134.

The control unit 103 is connected to the power distribution device 114 via a fifth control line 135 (which in FIG. 6 is shown interrupted) so as to control the power distribution device 114, and thus the distribution of the electrical energy that is introduced into the power distribution device 114 via the first power line 113 and the fourth power line 186.

The control unit 103 is moreover connected via a sixth control line 136 to the water electrolysis device 104 so as to control the same. A seventh control line 137 connects the control unit 103 to the fuel cell 108 (or to the hydrogen oxygen internal combustion engine having a generator) so as to control the same.

As is apparent from FIG. 6, a closed cycle of hydrogen gas (H₂), oxygen gas (O₂) and water (H₂O) is formed between the water electrolysis device 104 and the fuel cell 108 (or the hydrogen oxygen internal combustion engine), the cycle including the water reservoir 106 and the hydrogen supply container 107 and the oxygen supply container 107a, as is symbolized by the arrows. Due to the closed cycle, no impurities can enter the cycle, and the operating pressure of the system can be maintained constantly at a favorable value, regardless of the altitude.

This photovoltaic energy supply system provided in the high-altitude aerial vehicle according to the invention is thus fed only radiant solar energy S from the outside, wherein a portion of the electrical energy that is obtained is used to fill intermediate storage units (rechargeable battery storage unit 105 and hydrogen supply container 107), from which stored energy can then be retrieved and given off as electrical energy to the consumers if peak loads require this, or if no, or insufficient, radiant solar energy S is available.

The electrical energy thus obtained also drives the control surface machines, which in the described form operate the ailerons 13″, 14″ for bank control, the rudder 20 for yaw control, and the elevator 21 for pitch control.

The high-altitude aerial vehicle is controlled with precision by a control unit (not shown), which combines a differential GPS system and an inertial navigation system as well as a stellar attitude reference system with each other. The stellar attitude reference system automatically carries out optical stellar positioning and compares the result to a digitized celestial map that is carried on board. The measurement is carried out with a precision of approximately 25 microradian RMS. Such high precision is made possible by the high altitude in the stratosphere, in which visibility of the stars is virtually unimpaired by atmospheric disturbances. The position thus measured by a celestial sensor and the measured position angle are combined in a Kalman filter to form a precise navigation data record, to which the control unit of the aircraft and the sensors can resort to for attitude control of the solar generator 101 and/or of the payload nacelles.

By adding the stellar attitude reference system, the directional measurement of the sensors can become ten times as precise as compared to a GPS inertial navigation unit alone.

The hydrogen stored in the wing tanks fulfills the tasks of being both a lifting gas and the fuel for the fuel cell.

As an alternative, the aerial vehicle can be operated by a hydrogen oxygen internal combustion engine according to the diesel principle having a downstream exhaust gas turbocharger and high-pressure hydrogen injection unit, which achieves approximately the same efficiency as the electric motor having the fuel cell, but has a lighter weight. However, the internal combustion engine generates more vibrations than the electric motor, is louder, and consumes more energy for cooling.

Simultaneously providing a photovoltaic solar generator, a water electrolysis device, and a fuel cell in this energy supply system allows for the use of a portion of the electrical energy generated by the solar generator to generate hydrogen and oxygen from water during the daytime, when sufficient radiant solar energy is available, and to recombine the hydrogen with oxygen to obtain water in the fuel cell at night, when no radiant solar energy is available any longer, or when insufficient radiant solar energy is available, so as to generate electrical energy by way of the fuel cell.

For this purpose, the photovoltaic energy supply system is provided with the control unit 103, which is designed so that when radiant solar energy is present, the electrical energy generated by the solar generator is supplied to an electrical consumer connection of the energy supply system and, when radiant solar energy is not present or when the electrical energy generated by the solar generator is not sufficient for a predetermined energy requirement, the fuel cell is activated so as to supply electrical energy to the consumer connection. This control unit thus ensures that the fuel cell is automatically activated if insufficient or no radiant solar energy is available.

When radiant solar energy is present, the control unit 103 supplies a portion of the electrical energy generated by the solar generator to the water electrolysis device, and it supplies water from the water reservoir to the water electrolysis device, so that the water electrolysis device is activated, so as to generate hydrogen and oxygen using the supplied water, the hydrogen and oxygen being stored in the hydrogen and oxygen supply containers. A portion of the electrical energy generated by the solar generator is always used to operate the water electrolysis device, so as to generate the hydrogen that the fuel cell requires to generate electrical energy if the solar generator does not supply any, or not sufficient, electrical energy. The control unit can thus control the amount of electrical energy supplied to the water electrolysis device, or also the activation times of the water electrolysis device, as a function of the available hydrogen supply.

In this way, electrical energy is always available, which is either supplied directly by the solar generator or is generated indirectly by way of the fuel cell. The sole input energy for this system is the radiant solar energy, since water, hydrogen and oxygen form a cycle, which includes reservoirs for water, hydrogen and oxygen. The closed cycle has the advantage that no impurities can impair the operation. In addition, a constant ambient operating pressure is always maintained, regardless of the altitude, and no compressor work for the compression of the fuel gases is required at high altitudes.

If the aerial vehicle is configured with fully movable elevators 21, 21″ and rudders 20′, 20″, which are preferably attached to the fuselage 10 by way of a long empennage lever arm, maneuverability of the aerial vehicle is further improved. These elevators and rudders can also be designed in the same manner as the wings, so that particularly effective maneuverability of the aerial vehicle is achieved at the lowest weight.

Using the high-altitude aerial vehicles according to the invention, an aerial vehicle formation can fly in a long-term operation of the flying components of the formation, comprising at least one high-altitude refueling aircraft and at least one high-altitude aerial vehicle carrying a payload, day and night, and at the required altitudes and speeds, in permanent operation.

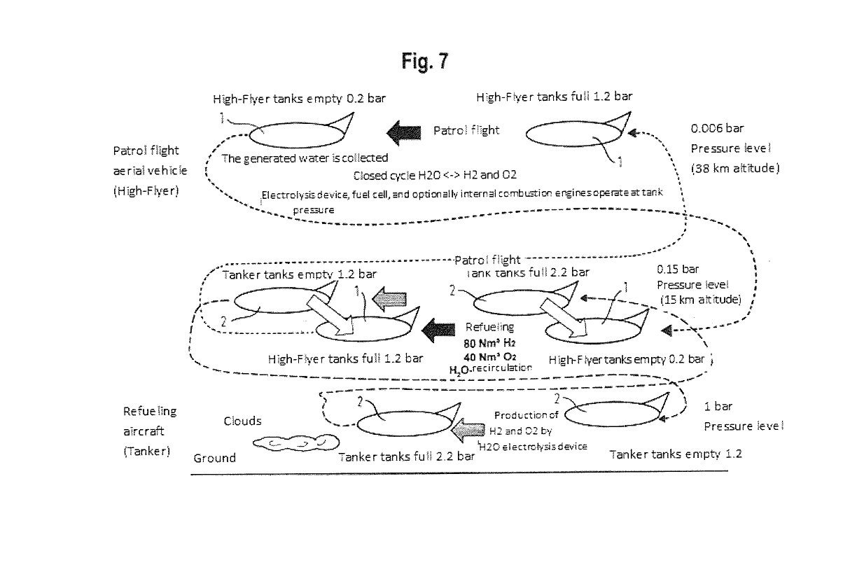

FIG. 7 is a schematic illustration of the sequence of a refueling cycle or operating cycle in an aerial vehicle formation according to the invention, as it is shown in FIG. 5 and has been described with reference to FIG. 5. The first high-altitude aerial vehicle 1 is a patrol aerial vehicle, which operates at a very high altitude, such as in the stratosphere, and carries out patrol flights there. This first high-altitude aerial vehicle is referred to as “High-Flyer” in FIG. 7.

A second high-altitude aerial vehicle 2, which serves as a refueling aircraft and is also referred to as “Tanker” in FIG. 7, operates at lower altitudes.

During the patrol flight, the patrol aerial vehicle 1 consumes hydrogen and oxygen for the generation of electrical energy in the fuel cell, and optionally also for direct combustion in a hydrogen internal combustion engine. During this consumption, water develops as a waste product, which is collected on board the patrol aerial vehicle 1. When the hydrogen and oxygen tanks of the patrol aerial vehicle 1 are full, these tanks have a pressure of 1.2 bar. When the tanks are empty, this pressure drops to 0.2 bar. It is thus still considerably higher than the ambient pressure of 0.006 bar prevailing at the patrol altitude.

If the pressure in the tanks of the patrol aerial vehicle 1 has dropped to below the lower threshold value of 0.2 bar, the patrol aerial vehicle 1 changes the altitude thereof and descends to a lower altitude, at which the external pressure is approximately 0.15 bar. There, the rendezvous described in connection with FIG. 5 between the refueling aircraft 2 and the patrol aerial vehicle 1 takes place, during which the tanks of the patrol aerial vehicle 1 are filled again with hydrogen and oxygen up to a pressure of 1.2 bar. During this refueling process, the water that has been collected in the patrol aerial vehicle is recirculated to the refueling aircraft. The internal pressure of the tanks of the refueling aircraft 2, which is 2.2 bar when the tanks are full, drops to 1.2 bar during the refueling process, which is to say to the maximum filling pressure of the patrol aerial vehicle 1.

After refueling has been carried out, the patrol aerial vehicle returns to its original altitude, and the refueling aircraft descends to a lower altitude, where an ambient pressure of approximately 1 bar prevails, for example, wherein this altitude is preferably above the ceiling so as to avoid unnecessary blocking of the solar cells of the refueling aircraft 2 by clouds. At this low altitude, hydrogen and oxygen are produced again from the recirculated water by the on-board electrolysis device of the refueling aircraft and the absorbed solar radiation and are stored in the corresponding tanks of the refueling aircraft until these have a pressure of approximately 2.2 bar. The refueling aircraft 2 is then ready again for a refueling operation.

A first design of the high-altitude aerial vehicle (High-Flyer) is thus suitable for flights at altitudes above 15 km and up to 38 m and cruising speeds of up to 66 m/sec over large ranges. For this purpose, this high-altitude aerial vehicle has a wing span of 50 m, a wing area of 250 m², and solar generator output of 30 kW around noon. The wing tanks can carry 80 standard cubic meters of hydrogen gas and 40 standard cubic meters of oxygen gas. For the high-altitude flight, an ultimate load factor of only 2.5 is adhered to for weight reasons, and a very lightweight skin, such as made of 25 μm thick MYLAR® film or Kevlar® film is used, which is not suitable for flights in dense turbulent air or rain. When integrated, this results in a high-altitude aerial vehicle that remains within a desired overall weight scope of 320 kg flight weight, for example, is able to carry a sensor payload of 50 kg and supply the same with energy, and delivers the necessary flight performance, which is to say a flight altitude of up to 38 km and a cruising speed of up to 66 m/sec over ranges of up to 8500 km without refueling over 36 hours.

A second design of the high-altitude aerial vehicle (Tanker) is suitable for collecting solar energy and for aerial refueling for flights at altitudes above 3 km and up to 21 km and cruising speeds of up to 30 m/sec at an altitude of 15 km over large ranges. For this purpose, this high-altitude aerial vehicle has a wing span of 50 m, a wing area of 250 m², and solar generator output of 30 kW around noon. The wing tanks can carry 80 standard cubic meters of hydrogen gas and 40 standard cubic meters of oxygen gas. For the solar energy collection flight at lower altitudes above the clouds, an ultimate load factor of 6 is adhered to for stability reasons, and a strong skin, such as made of 50 μM thick MYLAR® film or Kevlar® film is used, which is suitable for flights in dense turbulent air or light rain. When integrated, this results in an aerial vehicle that remains within a desired overall weight scope of 320 kg flight weight, for example, is able to carry a sensor payload of 50 kg and to supply itself and a patrol aerial vehicle (High-Flyer) with energy, and delivers the necessary flight performance, which is to say achieves a flight altitude of up to 21 km and a cruising speed of up to 30 m/sec over ranges of up to 3000 km without refueling over 30 hours.

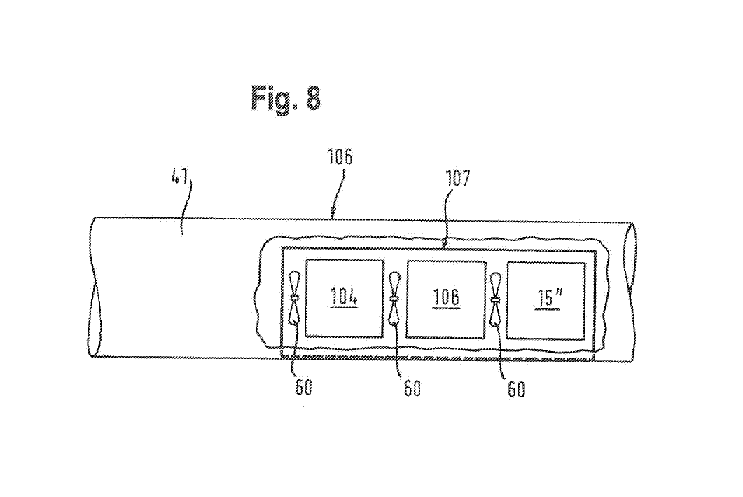

All work machines (such as the fuel cell 108, the hydrogen generator 104 and the motors 15″, 16″, 17″, the propeller and other heat generating electrical consumers 120) must be sufficiently cooled, which necessitates special measures, in particular at high altitudes having external pressures of up to 0.006 bar. The hydrogen generator 104, the fuel cell(s) 108 and the electric motors 15″, 16″, 17″, as is shown in FIG. 8, are preferably encapsulated in a pressure-resistant manner and disposed in the hydrogen supply container 107, which on the tanker is maintained at a constant absolute pressure of 2.2 bar by way of pumps and gas pressure control valves, and at 1.2 bar on the high-altitude aerial vehicle. The torque generated by the motors 15″, 16″, 17″ is transmitted from the pressure-resistant coverings to the outside, for example by way of magnetic couplings, and is passed on to the propellers.

Fans 60 in the hydrogen supply container 107 ensure that the work machines are cooled. The hydrogen supply container 107 is disposed in a large hydrogen reservoir (such as in the hose-like tubular spar 41), which is under variable operating pressure, but always has a lower pressure than the hydrogen supply container 107. The hydrogen supply tanks are connected in series among each other, so that the hydrogen gas can be circulated by the fans 60 and cools the hydrogen supply container having the work machines provided therein.

The hydrogen reservoirs dissipate their heat to the outside side, which is pumped by the fans through the spaces 48 between the hoses 40, 41, 42, 43, 44 forming the hydrogen or oxygen reservoirs for cooling purposes. Thus, advantageously the entire surface of the hydrogen reservoirs is used as a heat exchanger and consequently work machine cooling is assured, even at an external pressure of 0.006 bar.

This arrangement advantageously ensures cooling of all work machines, without requiring added weight for heat exchangers.

The respective motor 15″, 16″, 17″ is connected via a magnetic coupling through a gas-tight membrane, which seals all the tanks, to the propeller shaft of the associated propeller 15′, 16′, 17′, so that the gas tightness of the entire tank system is completely ensured.

In summary, the high-altitude aerial vehicles according to the invention have the following additional advantages:
The air space close to the ground and the ground can be monitored with substantially unlimited flying time as a result of the use of solar energy, and
solar-powered high-altitude flying can be maintained during the day and at night, in the summer and in the winter, with a substantially unlimited service life and a high payload proportion (such as 15%) of the flight weight.
Due to the large supply of energy and by using solar energy, the first high-altitude aerial vehicle (patrol aerial vehicle) can cover long distances (up to 6000 km round trip) at high altitude with a relatively high cruising speed of up to 250 km/h without refueling.
Members of the group having good energy supply and low consumption of their own can refuel members having a high need for energy in-flight with hydrogen gas.

Due to their design as a radome for sensors and data link systems, the patrol aerial vehicles can carry large lightweight antennas, which allow such installations to be constructed with low weight and low energy consumption.
Through the use of a special, large propeller, the high-altitude aerial vehicles can fly with low energy consumption, and as a result of a flapping hinge on the rotor shaft of the propeller, which keeps aerodynamic disturbance torques away from the propeller shaft, they can also fly largely free of vibrations, which allows the use of telescope cameras having long focal lengths on board.
Through the use of a laminar flow airfoil wing having a special design and by using the static lift of the hydrogen reservoir, the high-altitude aerial vehicles can fly an unlimited time with very low energy consumption using solar operation.

Reference numerals and signs in the claims, the descriptions and the drawings are only intended to provide a better understanding of the invention and are not intended to limit the scope of protection.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS AND SYMBOLS

They denote:
1 high-altitude aerial vehicle
2 refueling aircraft
10 fuselage
11 guyed pole
12 fuselage nose
13 left wing
13′ winglet
13″ aileron
14 right wing
14′ winglet
14″ aileron
15 first, left propulsion nacelle
15′ propeller
15″ motor
16 second, right propulsion nacelle
16′ propeller
16″ motor
17 third propulsion nacelle
17′ propeller
17″ motor
18 left upper guy wire
18′ right upper guy wire
19 left lower tensioning cable
19′ right lower tensioning cable
20 vertical stabilizer
20′ rudder
20″ rudder
21 horizontal stabilizer
21′ elevator
21″ elevator
30 landing gear
32 landing gear
34 solar cell panel
35 solar cell panel
36 solar cell panel
37 solar cell panel
40 hose
41 hose
42 hose
43 hose
44 hose
45 wing covering
46 wing spar
46′ inside tube
46″ outside tube
46′″ glued points
47 wing spar
48 space
50 refueling device
52 refueling tube
54 funnel-shaped receiving element
56 forward refueling tube
60 fan
101 solar generator
102 consumer connection
103 control unit
104 hydrogen generator
105 energy storage unit
106 water reservoir
107 hydrogen supply container
107a oxygen supply container
108 fuel cell
110 solar cells
112 carrier element
113 first power line
114 power distribution device
120 electrical consumer
130 first control line
132 second control line
134 third control line
135 fifth control line
136 sixth control line
137 seventh control line
140 second power line
144 first hydrogen line
145 oxygen line
146 electrically actuatable valve
147 electrically actuatable valve
154 hydrogen wing tanks
155 oxygen wing tanks
160 first water line
162 electrically actuatable valve
164 second water line
166 electrically actuatable valve
180 second hydrogen line
180a second oxygen line
181 electrically actuatable valve
182 electrically actuatable valve
184 intake opening
186 fourth power line
Q sun
S radiant energy
X vertical stabilizer pivot axis
Y pivot axis
Z fuselage axis

1-25. (canceled)

26. A high-altitude unmanned stratosphere aerial vehicle, comprising:
at least one fuselage;
at least two wings;
control surfaces; and
at least one propulsion system including at least one engine and at least one propeller, wherein each of the at least two wings
has a plurality of hoses,
has wing spars extending in a direction perpendicularly to a longitudinal fuselage axis,
is surrounded by a skin forming a wing covering that defines across-sectional contour of the wing, the cross-sectional contour forming a laminar flow airfoil that generates high lift when there is low flow resistance, and
has, at a free end facing away from the fuselage a winglet extending transversely to a longitudinal wing axis, wherein the winglet includes a movable control surface configured to generate an aerodynamic side force so as to bring the high-altitude unmanned stratosphere aerial vehicle to a banked position.

27. The high-altitude unmanned aerial vehicle of claim 26, wherein at least some of the plurality of hoses in each of the at least two wings are configured to be filled with hydrogen and at least some of the hoses in the at least two wings are configured to be filled with oxygen.

28. The high-altitude unmanned aerial vehicle of claim 27, wherein a volume ratio of hoses accommodating oxygen to hoses accommodating hydrogen is 1:2.

29. The high-altitude unmanned aerial vehicle of claim 26, wherein the skin of the wing covering is transparent at a top side of each of the at least two wings, and the top side of each of the at least two wings includes solar cells disposed between the transparent skin and the hoses.

30. The high-altitude unmanned aerial vehicle of claim 26, wherein the skin of the wing covering on a bottom side of the at least two wings is made of a high-strength aluminized aramid film.

31. The high-altitude unmanned aerial vehicle of claim 26, wherein each of the at least two wings includes at least one propulsion nacelle configured to accommodate a propulsion system.

32. The high-altitude unmanned aerial vehicle of claim 31, wherein
the at least one fuselage includes a guyed mast extending upward and downward away from the fuselage, and
tensioning devices brace the free ends of the at least two wings or the propulsion nacelles with respect to the fuselage or with respect to the guyed mast.

33. The high-altitude unmanned aerial vehicle of claim 26, wherein the wing spars are made of a two-member lattice tube design made of carbon fiber composite material.

34. The high-altitude unmanned aerial vehicle of claim 26, wherein the at least one propeller has helicopter rotor flapping hinges.

35. The high-altitude unmanned aerial vehicle of claim 26, wherein the at least one propulsion system comprises a hydrogen oxygen internal combustion engine.

36. The high-altitude unmanned aerial vehicle of claim 26, wherein the at least one propulsion system comprises an electric motor powered by a fuel cell.

37. The high-altitude unmanned aerial vehicle of claim 26, wherein the at least one fuselage includes fully moveable elevators at an aft section.

38. The high-altitude unmanned aerial vehicle of claim 26, wherein the at least one fuselage has at least one fully moveable rudder at an aft section.

39. The high-altitude unmanned aerial vehicle of claim 32, further comprising:
landing gear disposed at the guyed mast, an aft end of the fuselage, or a horizontal stabilizer.

40. The high-altitude unmanned aerial vehicle of claim 26, further comprising:
an electric drive machine; and
a photovoltaic energy supply system configured to generate propulsion energy, comprising
at least one photovoltaic solar generator configured to convert impinging solar radiant energy into electrical energy;
at least one water electrolysis device configured to generate hydrogen and oxygen from water, which operates at ground pressure that is kept constant so as to avoid contamination of the gases by hydrogen diffusion;
at least one water reservoir connected to the at least one water electrolysis device via a first water line;
at least one hydrogen supply container formed by a first hose and connected to the at least one water electrolysis device via a first hydrogen line;
at least one oxygen supply container formed by a second hose connected to the at least one water electrolysis device via a first oxygen line;
at least one fuel cell, which is configured to operate in a closed cycle at a ground pressure that is kept constant, so that contaminations of the fuel gases by carbon dioxide can be prevented, the fuel cell being connected to the hydrogen supply container via a second hydrogen line and being connected to the oxygen supply container via a second oxygen line and being further connected to the water reservoir via a second water line; and
a control unit, which is electrically connected to the solar generator, the water electrolysis device and the fuel cell.

41. The high-altitude unmanned aerial vehicle of claim 40, wherein the solar generator comprises at least one carrier element with CIGS thin-film solar cells and is formed by a thin polyimide film.

42. The high-altitude unmanned aerial vehicle of claim 41, wherein the solar cells are thin-film cadmium telluride solar cells.

43. The high-altitude unmanned aerial vehicle of claim 40, further comprising:
a rechargeable battery.

44. The high-altitude unmanned aerial vehicle of claim 40, wherein
the control unit is configured to supply the electrical energy generated by the solar generator to an electrical consumer connection of the energy supply system when radiant solar energy is present; and
the fuel cell is activatable to supply electrical energy to the consumer connection when radiant solar energy is not present or when the electrical energy generated by the solar generator is not sufficient for a predetermined energy requirement.

45. The high-altitude unmanned aerial vehicle of claim 40, wherein
the control unit is configured to supply a portion of the electrical energy generated by the solar generator to the at least one water electrolysis device when radiant solar energy is present; and
the control unit supplies water from the water reservoir to the water electrolysis device, so that the water electrolysis device is activated so as to generate hydrogen and oxygen from the supplied water, the hydrogen and oxygen being stored in the hydrogen reservoir and the oxygen reservoir.

46. The high-altitude unmanned aerial vehicle of claim 43, wherein a portion of the electrical energy generated by the solar generator or by the fuel cell is supplied to the rechargeable battery.

47. The high-altitude unmanned aerial vehicle of claim 40, wherein the solar generator is disposed in an interior of the skin of the aerial vehicle wing which is transparent at least on a top side.

48. The high-altitude unmanned aerial vehicle of claim 26, wherein the skin of the wing covering is rainproof, so that the aerial vehicle is also suitable for flying in a tropopause and a troposphere.

49. A system comprising:
first and second high-altitude unmanned aerial vehicles, each comprising:
at least one fuselage;
at least two wings;
control surfaces; and
at least one propulsion system including at least one engine and at least one propeller,
wherein each of the at least two wings
has a plurality of hoses,
has wing spars extending in a direction perpendicularly to a longitudinal fuselage axis,
is surrounded by a skin forming a wing covering that defines across-sectional contour of the wing, the cross-sectional contour forming a laminar flow airfoil that generates high lift when there is low flow resistance, and
has, at a free end facing away from the fuselage a winglet extending transversely to a longitudinal wing axis, wherein the winglet includes a movable control surface configured to generate an aerodynamic side force so as to bring the high-altitude unmanned stratosphere aerial vehicle to a banked position,
wherein the first high-altitude aerial vehicle is not rainproof and the skin of the wing covering of the second high-altitude aerial vehicle is rainproof, and
wherein the second high-altitude aerial vehicle is a refueling aircraft configured to refuel the first high-altitude aerial vehicle.

50. A method for operating a system comprising first and second high-altitude unmanned aerial vehicles, each comprising
at least one fuselage;
at least two wings;
control surfaces; and
at least one propulsion system including at least one engine and at least one propeller, wherein each of the at least two wings
has a plurality of hoses,
has wing spars extending in a direction perpendicularly to a longitudinal fuselage axis,
is surrounded by a skin forming a wing covering that defines across-sectional contour of the wing, the cross-sectional contour forming a laminar flow airfoil that generates high lift when there is low flow resistance, and
has, at a free end facing away from the fuselage a winglet extending transversely to a longitudinal wing axis, wherein the winglet includes a movable control surface configured to generate an aerodynamic side force so as to bring the high-altitude unmanned stratosphere aerial vehicle to a banked position,
wherein the first high-altitude aerial vehicle is not rainproof and the skin of the wing covering of the second high-altitude aerial vehicle is rainproof, and
wherein the second high-altitude aerial vehicle is a refueling aircraft configured to refuel the first high-altitude aerial vehicle,
wherein the method comprises:
establishing, by the second high-altitude aerial vehicle, a refueling connection with the first high-altitude aerial vehicle while the first and second high-altitude aerial vehicles are flying,
delivering, by the second high-altitude aerial vehicle, hydrogen gas to a hydrogen storage unit of the first high-altitude aerial vehicle;
delivering, by the second high-altitude aerial vehicle, oxygen gas to an oxygen storage unit of the first aerial vehicle;
returning, to the second high-altitude aerial vehicle, water from the first high-altitude aerial vehicle;
descending, by the second high-altitude aerial vehicle at an end of the delivery of hydrogen and oxygen gas and the return of the water, to a lower altitude, where the second high-altitude aerial vehicle generates hydrogen gas and oxygen gas by way of an on-board water electrolysis device and collected solar energy, using the taken-up water, and stores the generated hydrogen and oxygen gases in on-board hydrogen storage units or oxygen storage units; and
ascending, by the second high-altitude aerial vehicle after storing the generated hydrogen and oxygen gasses, to a higher flight altitude so as to be able to carry out another refueling process of a first aerial vehicle.
